(19) United States
(12) Patent Application Publication
(10) Pub. No.: US 2004/0108265 A1
(43) Pub. Date: Jun. 10, 2004

(54) Rainwater tank cleaning system

(76) Inventor: Warren Roy Agnew, Warkworth (NZ)

Correspondence Address: YOUNG & THOMPSON, 745 SOUTH 23RD STREET 2ND FLOOR, ARLINGTON, VA, 22202

(21) Appl. No.: 10/310,832

(22) Filed: Dec. 6, 2002

(51) Int. Cl. B01D 21/24

(52) U.S. Cl. 210/532.1

(57) ABSTRACT

A rainwater cleaning system for a water tank comprises a pipe member having a closed end located on the floor of the tank. The pipe member also has an open end connectable to an outflow from the tank. Located near the closed end of the pipe member is at least one hole. The surface area of the hole preferably equals the surface area of the outflow.

### BACKGROUND OF THE INVENTION

In many households dependent on the collection of rainwater as a source of drinking water, the collection area is normally the house roof and the rainwater is stored in a tank that can be constructed of iron, polyethylene, or concrete and which is located on a level below and in close proximity to the house roof so that the water flows by gravity down the spouting and to the storage tank.

Wind blown seeds, leaves, sticks, pollen, sand, road dust, bird droppings and dead insects etc can accumulate on the roof.

A problem associated with rainwater stored in a tank is a build-up of sediment and plant material, which has been carried off the roof along the spouting by the rainwater, and into the storage tank.

The sediment decaying, places an oxygen demand on the tank water. The process of decay can significantly lower the available oxygen in the water.

There are devices to minimise the plant material which is carried off the roof. Devices such as screens that fit into the gutters to prevent the accumulation of leaves and filters or leaf diverters on the spouting outlet and/or the entrance to the tank, also minimise the deposit of leaves in the tank. These devices do not however prevent smaller particles such as seeds, pollen, road dust, sand and broken parts of leaves and sticks etc from accumulating in the rainwater tank.

It is known to vacuum out tanks to remove the build up of sediment, in the same manner that swimming pools can be vacuumed out. The equipment to do so is expensive and it is normal for a householder to engage an independent contractor to occasionally clean out the tank. The cost of cleaning out a rainwater tank can be several hundred dollars.

As storage tanks are located below the roof, it is necessary to use a pump to either pump the water to a header tank to thus provide pressure to the household water system, or to use the pump itself to provide pressure to the household water system.

The pumps draw in and break down the water sodden plant material to minute but still visible particles that contaminate the household water supply.

Sometimes these particles can be clearly seen when a glass of water is poured and are more obvious when water is run into a bath.

In addition the impurities flow into the hot water cylinder where they cause a build up of material within the cylinder itself.

The inventor has come up with a novel and inexpensive system for removing the build up of sediment from rainwater tanks.

### OBJECT OF THE INVENTION

It is the object of the present invention to provide an improved rainwater cleaning system which will obviate or minimise the known problems in a simple yet effective manner or which will at least provide the public with a useful choice.

### STATEMENT OF INVENTION

A first aspect of the invention provides for a rainwater cleaning system comprising a pipe means having a closed end located on the floor of a tank and having an open end connectable to an outflow from the tank; located near the closed end of the pipe means is at least one hole, the surface area of the hole preferably equals the surface area of the outflow.

Preferably the pipe means has a number of holes, the combined surface area of the holes preferably equals the surface area of the overflow.

Preferably the combined surface area of the hole or holes equals the surface area of the outflow.

Preferably the outflow pipe has at least one anti-siphon means therein.

Preferably the anti-siphon means is a valve.

Preferably the outflow pipe has at least one air hole which permits the ingress of air and prevents the siphoning of water from the rainwater tank.

Preferably the pipe means comprises a single pipe located on the floor of the tank.

Preferably the pipe means comprises a number of pipes located on the floor of the tank.

A second aspect of the invention provides for a kit for use as a rainwater cleaning system comprising:

a) a pre-drilled pipe or pipes for the base of the tank,

b) an end cap or caps for the pre-drilled pipe or pipes,

c) a pipe to rise up the inside of the tank,

d) two right-angled bends,

e) PVC solvent glue,

f) A square of fine mesh.

In another aspect the rainwater cleaning system (tank-vac™) comprises a pipe means having a closed end located on the floor of the tank and having an open end connectable to an outflow from the tank. Located near the closed end of the pipe is at least one hole, preferably a number of holes; the combined surface area of the hole or holes preferably equals the surface area of the outflow. The outflow pipe preferably has at least one air hole on its upper surface which permits the ingress of air and prevents the siphoning of water from the rainwater tank.

### BRIEF DESCRIPTION OF THE DRAWINGS

The invention will now be further described by way of example only with reference to a preferred embodiment and to the attached drawings in which:

FIG. 1 is a section view of a preferred embodiment of the present invention.

FIG. 2 is an exploded view of the pipe as shown in FIG. 1.

FIG. 3 is an exploded view of the overflow pipe shown in FIG. 1.

FIG. 4 shows a flexible pipe as a second embodiment of the present invention.

FIG. 5 shows a pipe means having multiple pipes as a third embodiment of the present invention.

FIGS. 6-8 are exploded perspective views of alternative outflow structures.

### DETAILED DESCRIPTION OF THE DRAWINGS

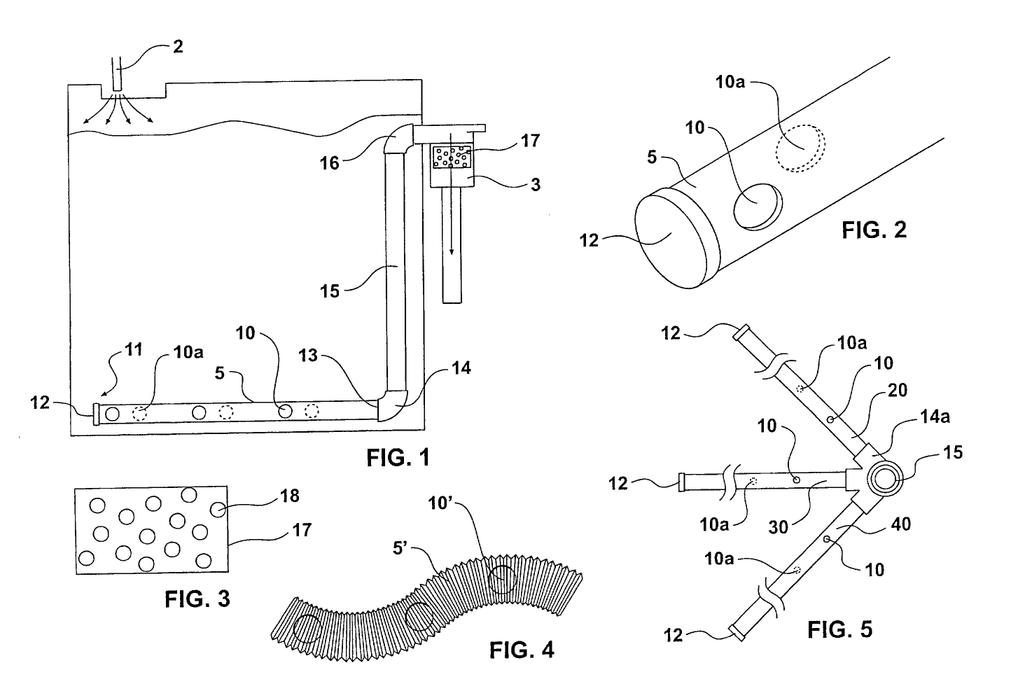

Shown in FIG. 1 is the tank-vac˜ system installed in a plastic rainwater tank 1 having an inlet 2 and a pipe means including an outlet 3. A rainwater pipe 4 from the roof discharges water into the inlet 2. When the water from the inlet 2 enters the tank the water level is raised above outlet 3 causing the tank to overflow.

The pipe means also includes at least one polyethylene pipe 5 having six identically sized holes 10 and 10A cut in the sides of the pipe 5. The free end 11 of the pipe 5 is sealed usually with a cap 12. The other end 13 is attached to an elbow 14 which is itself attached to a second pipe 15. The pipe 15 is connected to a second elbow means 16 which is itself connected to the outlet pipe 3.

In FIG. 3 is shown an exploded view of the small holes 18 formed in outlet pipe 3 at 17, to prevent a siphoning effect from the invention. The discharge area of the outlet pipe 3 is the same as the total area of the holes 10 and 10A cut into the pipe 5.

### WORKING EXAMPLE 1

A 150 litre tank was used for trials. A 40 mm diameter PVC water pipe had one end sealed and six holes drilled into it. This pipe was placed on the base of the plastic water tank. The surface area of the six holes equalled the surface area of the discharge outlet for maximum outflow. Various types of sediment were placed in the tank and the tank was caused to overflow. When the tank overflowed the sediment was drawn into the six holes in the pipe and exited from the tank via the outlet. The amount of sediment exiting the tank could be clearly measured from observing changes in the colour of the water exiting the tank. Regardless of whether leaves, dirt or sand particles were used as sediment, the result was an almost instant removal of the sediment whenever the tank overflowed.

### WORKING EXAMPLE 2

In a similar manner to Example 1 the invention was trialed on a 4,000 gallon rainwater tank. The only difference was that an 80 mm PVC water pipe was used rather than the 40 mm PVC pipe. Again six holes were drilled in the pipe and sediment was added to the tank. When the tank was caused to overflow, the sediment was drawn out of the tank through the holes in the pipe.

When water flows from the house roof and enters the inlet 2 of the tank; rather than flowing directly through the outflow 3, the tank-vac™ system causes the water at the base of the tank to enter the holes 10 and 10a located in the pipes at the base of the tank 1. The water entering the holes 10 and 10a in the pipe 5 draws in the sediment, plant material, dirt and other particulate solids on the base of the storage tank and by siphon action washes them out through the overflow 3. In this way the fresh water entering the tank is not immediately removed by the overflow and the tank is automatically cleaned.

The tank-vac™ overflow system provides for cleaning of the rainwater tank whenever the water storage system begins to overflow.

As seen in FIG. 2 the section of pipe means 5 that lies on the base of the tank has a number of holes 10 and 10a drilled into the side of the pipe. The size of the holes and the number of holes 10 and 10a can be varied to take account of particular contaminant problems.

If large leaves have been drawn into the water storage system then the holes in the flexible pipe can be made of sufficient diameter to allow the leaves to be drawn into the pipe and discharged from the overflow.

Whilst the cleaning action will work regardless of the size and number of holes in the pipe it is preferably that the total surface area of the holes drilled into the tank-vac™ pipe equal the surface area of the water tank overflow. The suction is maintained through the siphon system. This invention allows the older less oxygenated water in the tank to be expelled whenever fresh water enters the tank.

To prevent excess water siphoning from the storage tank the tank-vac system is controlled by forming of at least one air hole in the top of the overflow pipe and on the outside of the tank.

It is envisaged that the invention would be sold as a kit with instructions. The kit comprising the following:

A pre-drilled pipe for the base of the tank;

An end cap for the pre-drilled pipe;

A pipe to rise up the inside of the tank;

Two right-angled bends;

PVC solvent glue;

A square of fine mesh

In tanks which are not readily accessible, it may be necessary to make a new overflow outlet or to position the pipe within the tank by means of mechanical tongs.

Whilst the invention has been described with particular reference to a rigid pipe, it is quite clear that the invention will also work with flexible piping as shown in FIG. 4, which will allow for movement of the pipe around the base of the tank.

In place of a single pipe, multiple pipes 20, 30 and 40 can be used as shown in FIG. 5. Many different pipe configurations for the pipe means are envisaged. For example a single pipe 5 leading to at least one vertical pipe section 15 or pipe 5 can be a series of pipes fanning out from a single pipe or a circular shape or there can be pipe the length of the diameter of the tank with at least one pipe radiating or at right angles thereto. It is necessary to cover the tank bottom so that substantially all contaminants can be removed. This will depend on what level is required. If the diameter length of pipe is used, this can be easier to install and insert into the tank as it is less likely to bend when lowering to the tank bottom. With different pipe configurations, different positions for the inlet and outlet pipes are also possible.

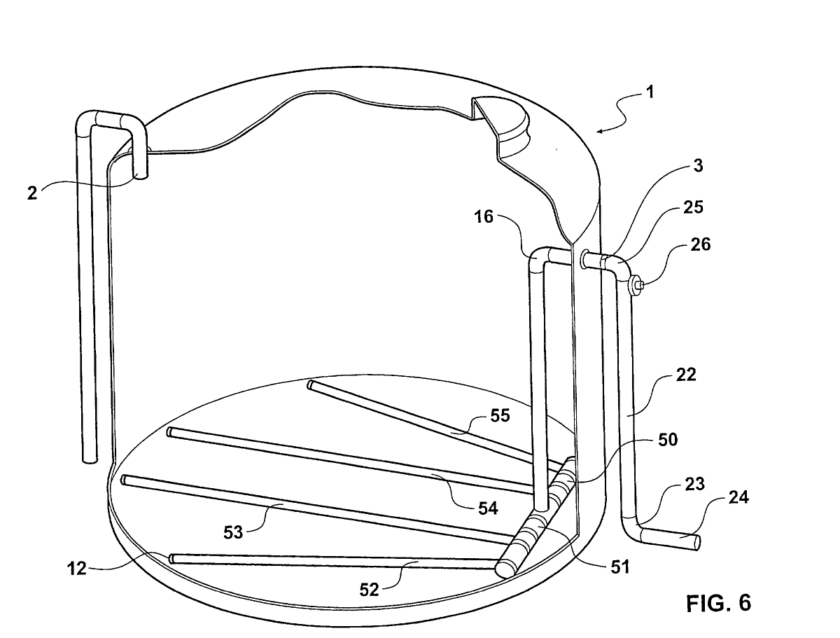

In FIGS. 6-8 there are further embodiments of the invention wherein the outflow pipe-work inside the tank or outside of the tank, can be in another form or configuration. The outlet 3 can have a vertical portion 22 joined by another elbow 23 to a horizontal portion 24. Another elbow 25 can be used to join to the outlet 3. This structure can be used to increase fluid flow through the pipe means which can serve to create surges to loosen and remove any block from leaves etc. The outlet can include an anti-siphon means 26 located such that any possible siphoning can not occur. The anti-siphon means can be at least one correctly positioned aperture or a valve. This outlet structure can be combined with the outlet structure of FIG. 1. The anti-siphon member for example can be a valve member such as a Hunter™ valve or at least one aperture.

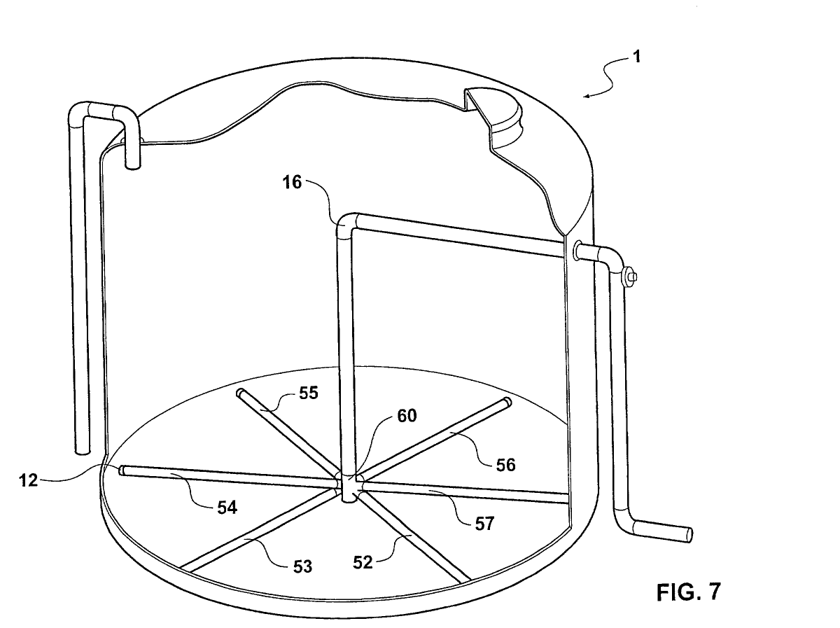

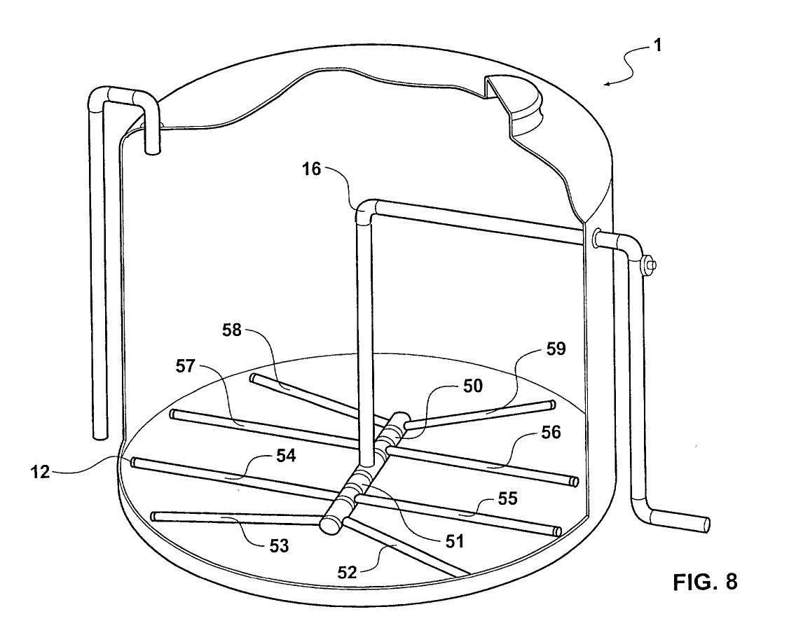

FIGS. 6, 7 and 8 show examples of various pipe configurations. Also integral pipe lengths and various joining methods are also possible. If the tank is a different shape (eg square, rectangular etc) then other pipe configurations are also envisaged. In FIG. 6 there is a feeder portion 50 and 51 with pipes 52-55 being connected thereto. FIG. 7 shows a radial pipe configuration having a central node connector 60 with several spokes or pipes 52-57 while the example in FIG. 8 shows a diameter branch type length 50 and 51 with branches 52-59. Many variations are possible.

Throughout the description of this specification the word “comprise” and variations of that word, such as “comprising”, are not intended to exclude other additives, components, integers or steps.

To those skilled in the art to which the invention relates, many changes in construction and widely differing embodiments and applications of the invention will suggest themselves without departing from the scope of the invention as defined in the appended claims. The disclosures and the description herein are purely illustrative and are not intended to be in any sense limiting.

What I claim is:

1: A rainwater cleaning system comprising a pipe means having a closed end located on the floor of a tank and having an open end connectable to an outflow from the tank; located near the closed end of the pipe means is at least one hole, the surface area of the hole preferably equals the surface area of the outflow.

2: A rainwater cleaning system as claimed in claim 1 wherein the pipe means has a number of holes, the combined surface area of the holes preferably equals the surface area of the overflow.

3: A rainwater cleaning system as claimed in any one of claims 1 or 2 wherein the combined surface area of the hole or holes equals the surface area of the outflow.

4: A rainwater cleaning system as claimed in any one of the preceding claims wherein the outflow pipe has at least one anti-siphon means therein.

5: A rainwater cleaning system as claimed in claim 4 wherein the anti-siphon means is a valve.

6: A rainwater cleaning system as claimed in claim 4 wherein the outflow pipe has at least one air hole which permits the ingress of air and prevents the siphoning of water from the rainwater tank.

7: A rainwater cleaning system as claimed in any one of the preceding claims wherein the pipe means comprises a single pipe located on the floor of the tank.

8: A rainwater cleaning system as claimed in any one of claims 1-6 wherein the pipe means comprises a number of pipes located on the floor of the tank.

9: A kit for use as a rainwater cleaning system comprising
a) a pre-drilled pipe or pipes for the base of the tank,
b) an end cap or caps for the pre-drilled pipe or pipes,
c) a pipe to rise up the inside of the tank,
d) two right-angled bends,
e) PVC solvent glue,
f) A square of fine mesh.
